(19) United States
(12) Patent Application Publication
(10) Pub. No.: US 2016/0062137 A1
(43) Pub. Date: Mar. 3, 2016

(54) Extreme sports glasses

(71) Applicant: Rodrigo Perez, Dayton, OH (US)

(72) Inventor: Rodrigo Perez, Dayton, OH (US)

(21) Appl. No.: 14/121,389

(22) Filed: Aug. 29, 2014

(51) Int. Cl. G02C 3/00; G02C 11/00

(52) U.S. Cl. CPC G02C 3/003; G02C 11/10

(57) ABSTRACT

The Extreme Sports Glasses are a design with a functionality that allows the ear portion to wrap around the back of the ear with a flexible portion from the ear lobe to the ear canal for the ear bud to be placed inside the ear canal and be held in place while being active in extreme sports activities.

### BACKGROUND OF THE INVENTION

(1) Field of the Invention

The Extreme Sports Glasses is in a field of other sports related glasses and with glasses that have a stereo capability or a blue tooth capability.

(2) Description of the Art Including Information Disclosed Under 37 CFR 1.97 & 1.98

The art described in the drawings of the design and utility function illustrate the unique ability of the Extreme Sports Glasses wrap around a person's ear and stay in place. We have found no other patents that were similar in that design and functionality.

### BRIEF SUMMARY OF THE INVENTION

The Extreme Sports Glasses ear piece portion wrap around the ear and hold in place while being active in sports activities.

### BRIEF DESCRIPTION OF THE SEVERAL VIEWS OF THE DRAWINGS

There are 3 drawings in total that describe and illustrate the design and function of the Extreme Sports Glasses.

FIG. 1: is the side elevation view of the glasses with the microphone attached.

FIG. 2: is the ¾ perspective view with the microphone detached.

FIG. 3: is the rear elevation view with the microphone detached.

### DETAILED DESCRIPTION OF THE PREFERRED EMBODIMENT

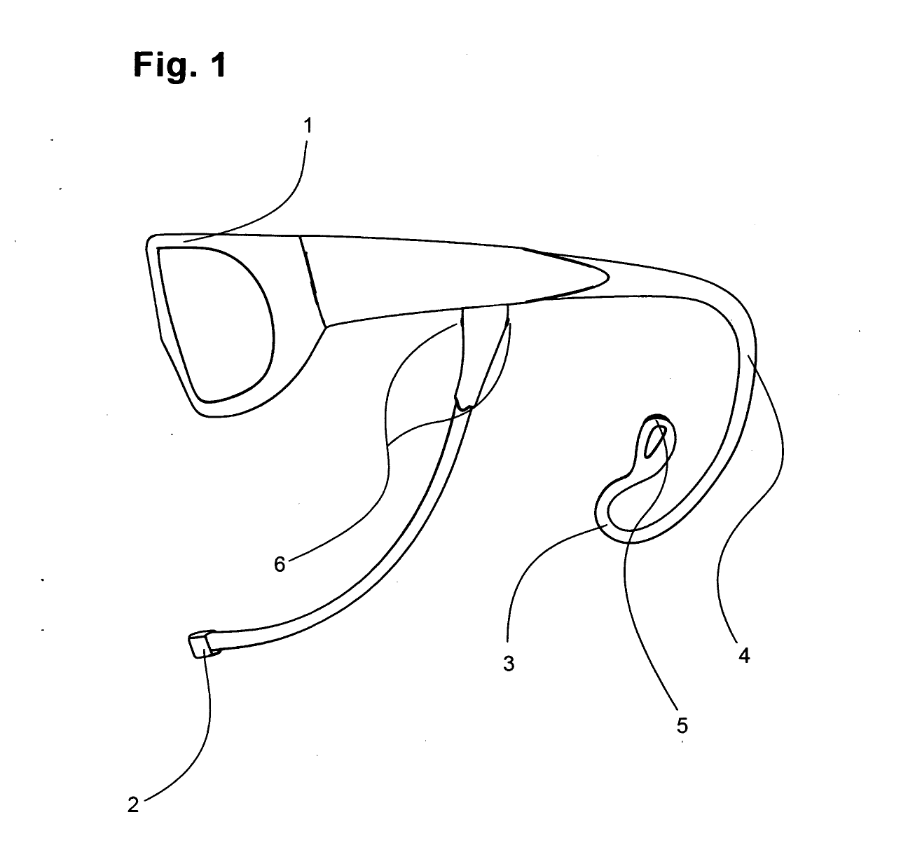

FIG. 1: In this side elevation view illustration #1 is the frame of the glasses with #2 the detachable microphone with #3 the flexible portion of the wrap around ear piece with #4 the more rigid portion of the wrap around ear piece with #5 the ear bud portion that fits into the ear from the bottom of the ear with #6 the buttons to release the microphone and to attach the microphone.

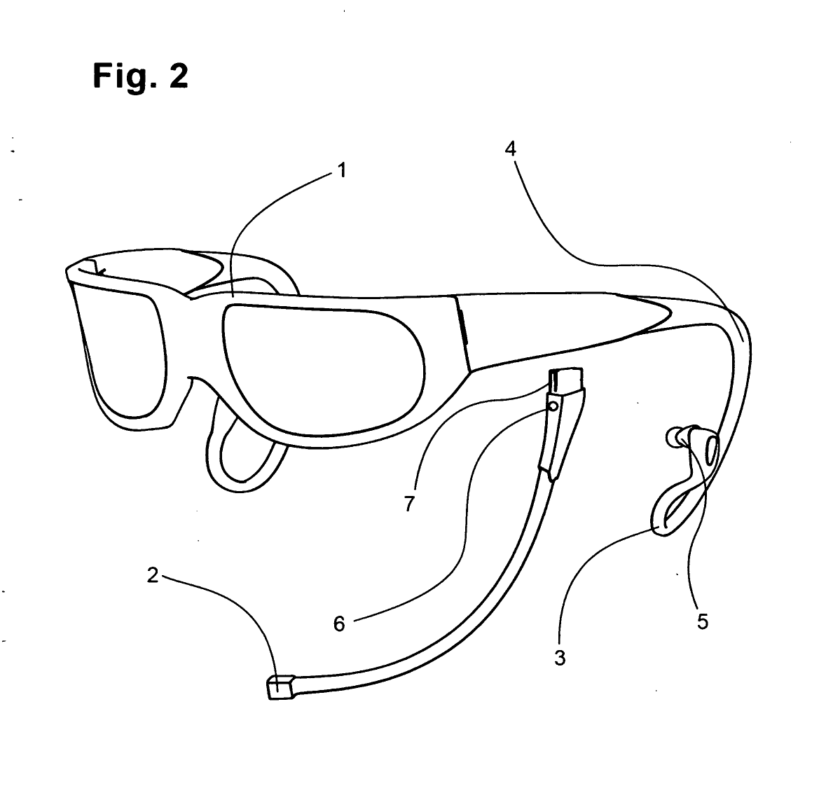

FIG. 2: In this ¾ perspective view illustration #1 is the frame of the glasses with #2 the detachable microphone with #3 the flexible portion of the wrap around ear piece with #4 the more rigid portion of the wrap around ear piece with #5 the ear bud portion that fits into the ear from the bottom of the ear with #6 the buttons to release the microphone and to attach the microphone with #7 the male insert attachment portion of the microphone.

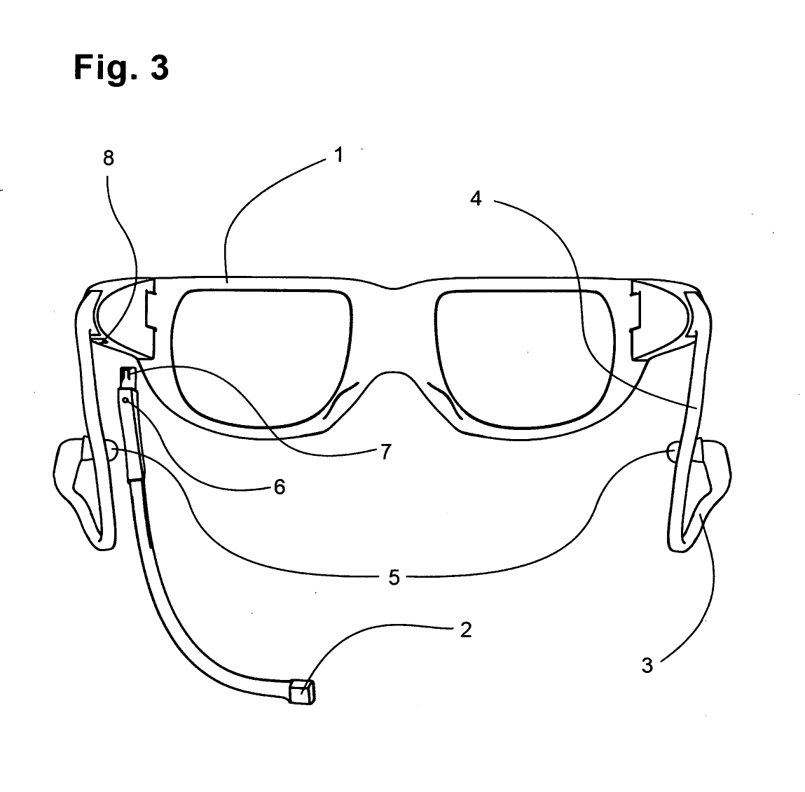

FIG. 3: In this rear elevation view illustration #1 is the frame of the glasses with #2 the detachable microphone with #3 the flexible portion of the wrap around ear piece with #4 the more rigid portion of the wrap around ear piece with #5 the ear bud portion that fits into the ear from the bottom of the ear with #6 the buttons to release the microphone and to attach the microphone with #7 the male insert attachment portion of the microphone with #8 the female insert attachment portion of the glasses.

### DETAILED DESCRIPTION OF THE INVENTION

The Extreme Sports Glasses are a new concept in wearing glasses while active in extreme sports and having the glasses stay on the head. The wrap around behind the ear design allows for a tight grip on the glasses to the head. The wrap around portion comes around the back of the ear and up from the bottom front of the ear lobe and has a flexible portion between the ear lobe and the ear canal that allows the ear bud portion to be placed into the ear canal and be a tight fit. The temple portion of the glasses can have buttons of any type for a blue tooth capability or a stereo capability with an attachable and detachable microphone for when a person just want to listen the stereo or I Phone for instance and then to talk on the blue tooth allowing a noise reduction microphone to be used. We are not trying to patent the blue tooth or stereo. We are focusing on the wrap around ear portion and the microphone capability.

What is claimed is:

1. A pair of Extreme Sports Glasses comprising of:
a frame of the glasses with temple portion with the detachable microphone;
a flexible portion of the wrap around ear piece extending from the more rigid portion of the behind the ear wrap around ear piece with the ear bud portion that fits into the ear from the bottom of the ear between the ear lobe and the ear canal;
a set of buttons on both sides of the microphone to release the microphone and to attach the microphone with the male insert attachment portion of the microphone with the female insert attachment portion of the glasses.
